(19) United States
(12) Patent Application Publication
(10) Pub. No.: US 2026/0317037 A1
(43) Pub. Date: Oct. 15, 2026

(54) Transport Packaging Having a High Shock-Absorbing Effect, Line and Production Method for Transport Packaging

(71) Applicant: Grifal S.P.A., Cologno Al Serio (IT)

(72) Inventor: Fabio Angelo Gritti, Cologno Al Serio (IT)

(21) Appl. No.: 19/482,925

(22) PCT Filed: Apr. 18, 2024
(86) PCT No.: PCT/EP2024/060607

§ 371 Date: Nov. 10, 2025

(30) Foreign Application Priority Data
May 11, 2023 (IT) 102023000009420

(51) Int. Cl. B65D 81/03; B65B 5/02; B65B 5/04; B65B 11/00; B65B 11/12; B65B 11/48; B65B 43/10; B65B 55/20; B65B 65/00; B65D 5/02

(52) U.S. Cl. CPC B65D 81/03; B65B 5/024; B65B 5/04; B65B 11/004; B65B 11/12; B65B 11/48; B65B 43/10; B65B 55/20; B65B 65/003; B65D 5/0209; B65B 2210/04

(57) ABSTRACT

A transport packaging having a high shock-absorbing effect, comprising a shaped element made of corrugated cardboard and having, in a flat extension thereof, a shape adapted to be folded back on itself to form a three-dimensional shape, the shaped element having, in a three-dimensional shape, a prism-like geometry with a substantially elliptical base to accommodate an item to be packaged wedged at its edges between corrugations of the corrugated cardboard and with its main faces spaced from the walls of the shaped element so as to allow the elastic deformation of the walls in the direction of the item to be packaged in case of accidental falls and/or impacts, taking advantage of the elastic properties of corrugated cardboard.

### CROSS-REFERENCE TO RELATED APPLICATIONS

This application is the National Stage of International Application No. PCT/EP2024/060607 filed Apr. 18, 2024, which claims priority to and the benefit of Italian Application No. 102023000009420 filed May 11, 2023, the disclosures of both of which are incorporated herein by this reference in their entireties.

### FIELD OF THE INVENTION

The present invention relates to a transport packaging having a high shock-absorbing effect and to the related production line and method.

### BACKGROUND OF THE INVENTION

In the protective packaging field, the need to cushion the impacts that a package inevitably experiences during transport to its final destination is well known.

Typically, in order to provide a container that is effective against the above-mentioned impacts, the size, weight, fragility of the contents, as well as the mode of transportation are evaluated.

Based on this information, it is possible to determine what shocks the package may experience and what level of cushioning is needed to limit the impact decelerations transmitted to the package contents.

The most common practice is to insert, between the container and the contents, shock-absorbing elements that allow less violent decelerations, limiting the peak deceleration caused by impact.

This known practice is not without drawbacks, among which there is the fact that inserting shock-absorbing elements entails significant additional costs in the provision of the packaging, due both to the cost of the shock-absorbing elements and the additional costs attributable to their procurement, as well as their logistical management.

Another drawback of this known practice is that the insertion of the cushioning elements extends the packaging time and increases the possibility of making assembly errors that operators may make during the provision of the packaging itself, consequently increasing costs.

An additional drawback of this known practice is that from the end consumer's point of view the cushioning elements become waste to be disposed of.

### BRIEF SUMMARY OF THE INVENTION

The aim of the present invention is to provide a transport packaging having a high shock-absorbing effect that is free from additional cushioning elements, so as to protect the packaged item during the steps of handling and transport.

Within this aim, an object of the present invention is to provide a transport packaging that makes use of technologies known in the field and thus has competitive provision costs.

Another object of the present invention is to provide a packaging that can be easily disposed of by separate collection.

Finally, a further object of the present invention is to provide a packaging that offers the greatest assurances of effectiveness in protecting the contents against accidental impacts.

This aim, as well as these and other objects which will become better apparent hereinafter, are achieved by a transport packaging having a high shock-absorbing effect, comprising a shaped element made of corrugated cardboard and having, in its flat extension, a shape adapted to be folded back on itself to form a three-dimensional shape; characterized in that said shaped element has, in said three-dimensional shape, a prism-like geometry with a substantially elliptical base to accommodate an item to be packaged wedged at its edges between the corrugations of said corrugated cardboard and with its main faces spaced from the walls of said shaped element so as to allow the elastic deformation of said walls in the direction of said item to be packaged in case of accidental falls and/or impacts, taking advantage of the elastic properties of said corrugated cardboard.

This aim, as well as these and other objects that will become better apparent hereinafter are also achieved by a line for the production of a transport packaging, characterized in that it comprises:
a loading station, in which the dimensions and weight of an item to be packaged are measured by virtue of measurement means,
a magazine of rolls of corrugated cardboard of different sizes;
calculation means adapted for the identification of the roll of corrugated cardboard and of the shaped element that are most adapted for the provision of a packaging adapted to contain said item to be packaged on the basis of measurements taken in said loading station by said measurement means;
a station for picking up and unrolling said roll along an advancement line from which said shaped element is to be obtained;
a creasing station, comprising a creasing device which is movable along a first direction that is perpendicular to the working surface on which said roll is unrolled, so as to allow its approach and spacing with respect to said unrolled roll, and along a second direction that is perpendicular to both said first direction and said advancement line, so as to crease said unrolled roll along folding lines calculated by said calculation means by combining the relative motion between said unrolled roll that is advancing along said advancement line and the creasing blades of said creasing device which can move along said second direction;
a cutting station, comprising one or more blades which can move along said first direction, in such a manner as to allow them to move toward and away from said unrolled roll, and along said second direction, so as to cut said unrolled roll to obtain said shaped element calculated by said calculation means by combining the relative motion between said unrolled roll advancing along said advancement line and said blades which can move along said second direction;
a positioning station, in which said item to be packaged is positioned on said shaped element obtained from said cut and creased roll;
a folding station, in which said shaped element is closed onto said item to be packaged by wrapping and wedging it at its edges between the corrugations of said corrugated cardboard and with its main faces spaced from the walls of said shaped element so as to allow the elastic deformation of said walls in the direction of said item to be packaged in the event of accidental falls and/or impacts by taking advantage of the elastic properties of said corrugated cardboard;
a sealing station, in which said shaped element is sealed by means of adhesive tape and labeled.

Finally, this aim, as well as these and other objects that will become better apparent hereinafter, are also achieved by a method for providing a transport packaging, by means of a production line, characterized in that it comprises the following steps:
loading an item to be packaged and detecting the dimensions and weight of said item to be packaged by virtue of measurement means;
identifying, by virtue of said calculation means, the roll of corrugated cardboard and the shaped element that are most adapted for the provision of a packaging adapted to contain said item to be packaged on the basis of the measurements made by said measurement means;
picking up and unrolling said roll along an advancement line and obtaining said shaped element from said roll;
creasing said unrolled roll along folding lines calculated by said calculation means by combining the relative motion between said unrolled roll that is advancing along said advancement line and the creasing blades of a creasing device which can move transversely with respect to said advancement line;
cutting said unrolled roll to obtain said shaped element calculated by said calculation means by combining the relative motion between said unrolled roll that is advancing along said advancement line and blades which can move transversely with respect to said advancement line;
positioning said item to be packaged on said shaped element obtained from said cut and creased roll;
folding said shaped element over said item to be packaged by wrapping it and wedging it at its edges between the corrugations of said corrugated cardboard and with its main faces spaced from the walls of said shaped element so as to allow the elastic deformation of said walls in the direction of said item to be packaged in the event of accidental falls and/or impacts, taking advantage of the elastic properties of said corrugated cardboard;
sealing said shaped element by means of adhesive tape and labeling said shaped element.

### BRIEF DESCRIPTION OF THE DRAWINGS

Further characteristics and advantages of the invention will become better apparent from the description of a preferred but not exclusive embodiment in four variations of a transport packaging, illustrated by way of non-limiting example in the accompanying drawings, wherein:

FIG. 1 is a perspective view of a transport packaging according to the invention;

FIG. 2 is a top plan view of the transport packaging shown in FIG. 1;

FIG. 3 is a perspective view of the transport packaging shown in FIGS. 1 and 2 and wrapped in an adhesive tape;

FIG. 4 is a transverse sectional view of the transport packaging shown in the preceding figures;

FIGS. 5 to 12 are, respectively, four top plan views and four perspective views of four variations of corrugated cardboard shaped elements with which to provide the transport packaging shown in the preceding figures;

FIG. 13 is a perspective view of a schematic production line of a transport packaging according to the invention;

FIG. 14 is a top plan view of the production line shown in the preceding figure.

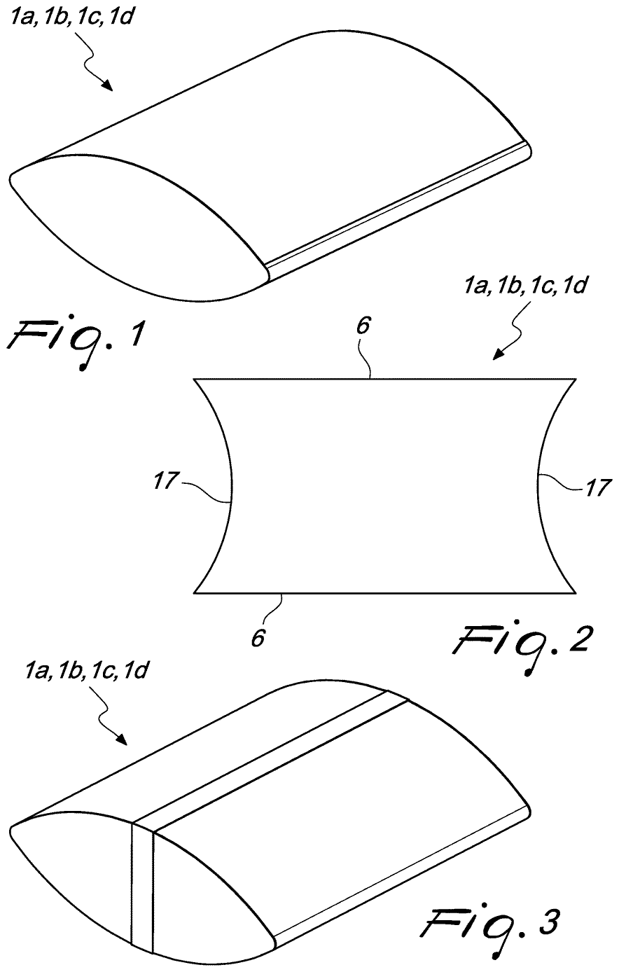

### DETAILED DESCRIPTION OF THE INVENTION

With reference to the figures, the transport packaging having a high shock-absorbing effect, designated in the four proposed variations by the reference numerals 1a, 1b, 1c and 1d, respectively, comprises a shaped element 2a, 2b, 2c or 2d made of corrugated cardboard—preferably of high thickness—and having, in its flat extension, a shape adapted to be folded back on itself to form a three-dimensional shape.

According to the invention, the shaped element 2a, 2b, 2c or 2d has, in the three-dimensional configuration, a prism-like geometry with a substantially elliptical base to accommodate an item to be packaged 3 so that it is wedged at its edges 4 between the corrugations 5 of the corrugated cardboard and with its main faces 6 spaced from the walls of the shaped element 2a, 2b, 2c, or 2d so as to allow elastic deformation of the walls in the direction of the element to be packaged 3 in the event of accidental falls and/or impacts by taking advantage of the elastic properties of corrugated cardboard.

Advantageously, the folding lines 7 of the shaped element 2a, 2b, 2c and 2d are provided by creasing and are oriented substantially transversely to the orientation of the corrugations 5 of the corrugated cardboard.

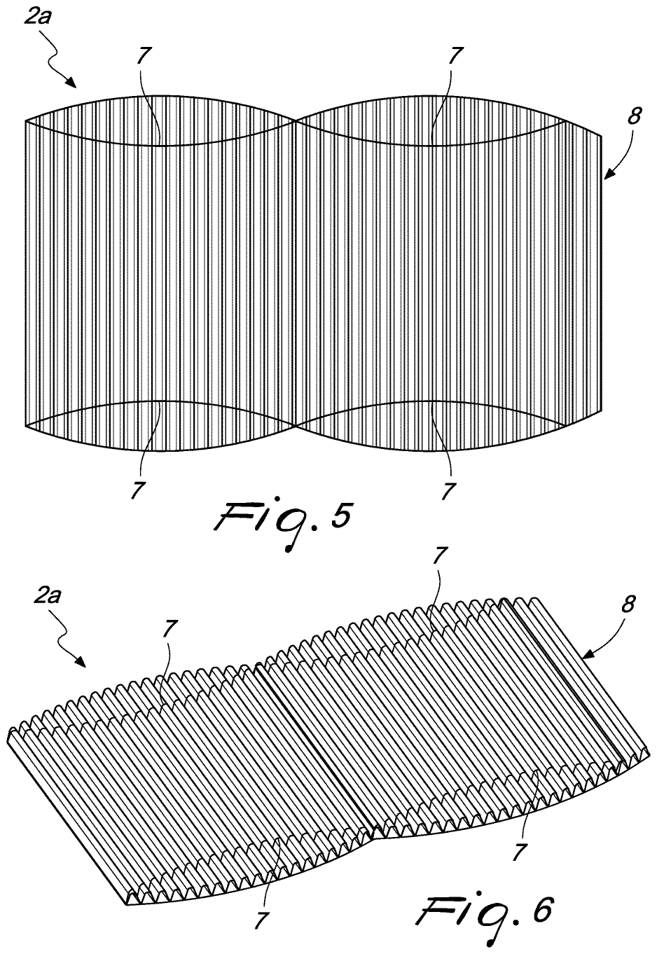

Moreover, with reference to the first variation la shown in FIGS. 4 and 5, the shaped element 2a may comprise at least one closing tab 8 which can be superimposed, in the three-dimensional configuration, on an outer portion of the shaped element 2a to seal it.

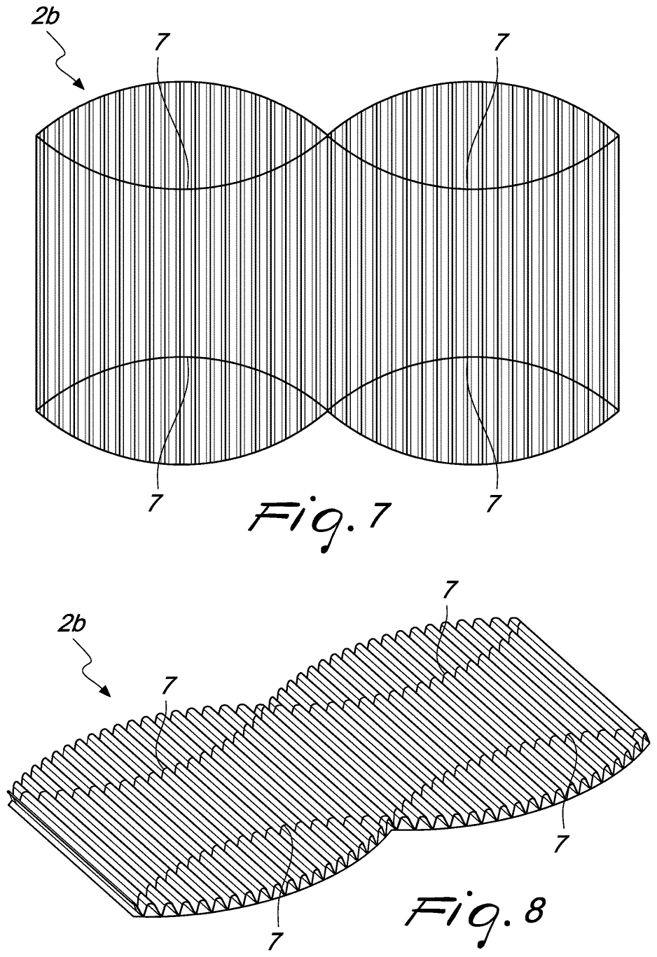

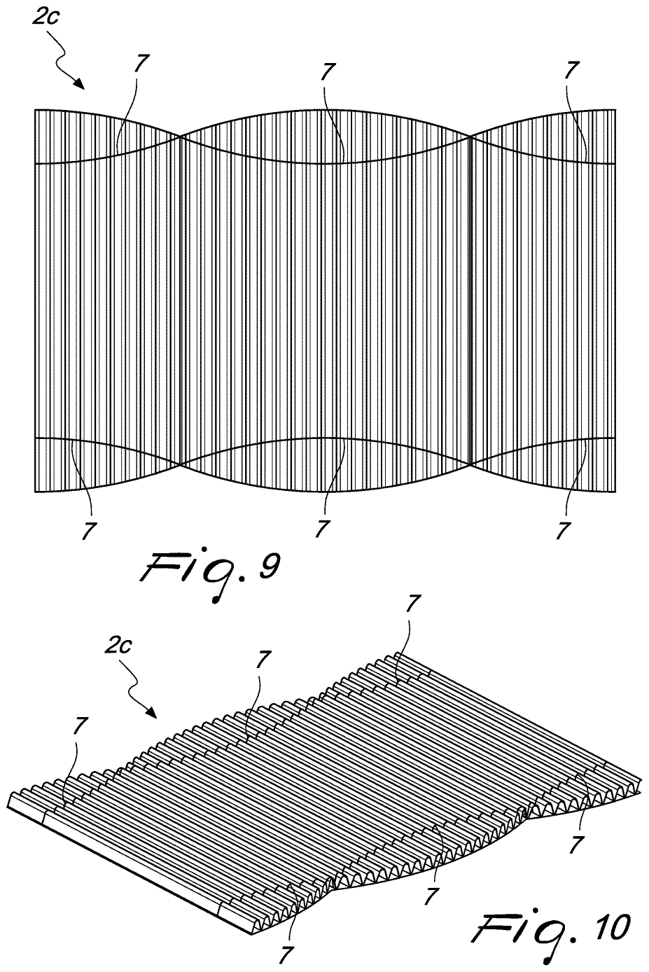

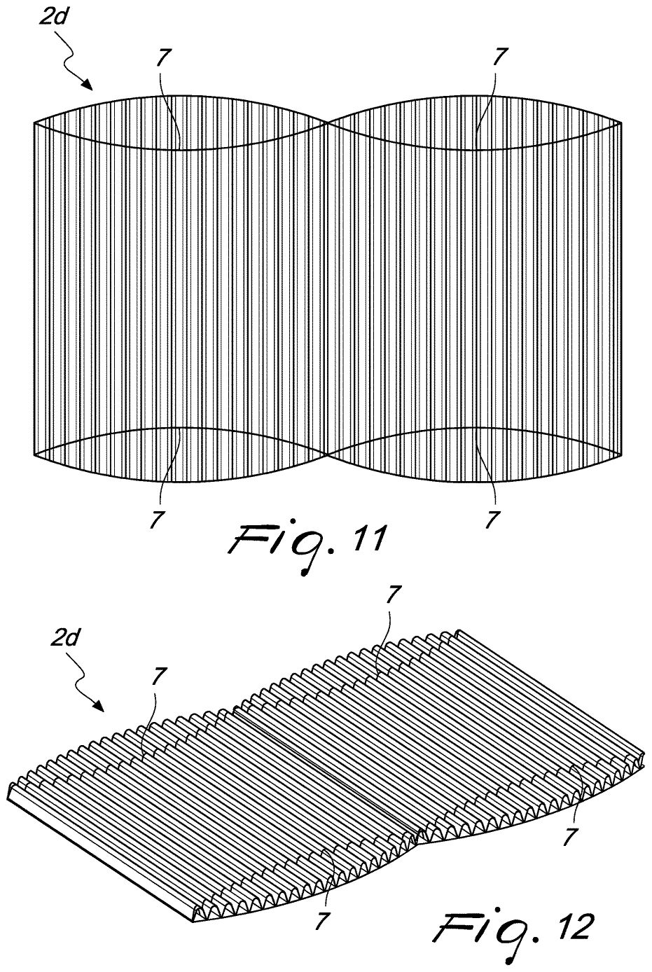

As will become better apparent hereinafter, the shaped elements 2a, 2b, 2c and 2d may have different sizes and shapes as needed, as shown in FIGS. 4 to 11.

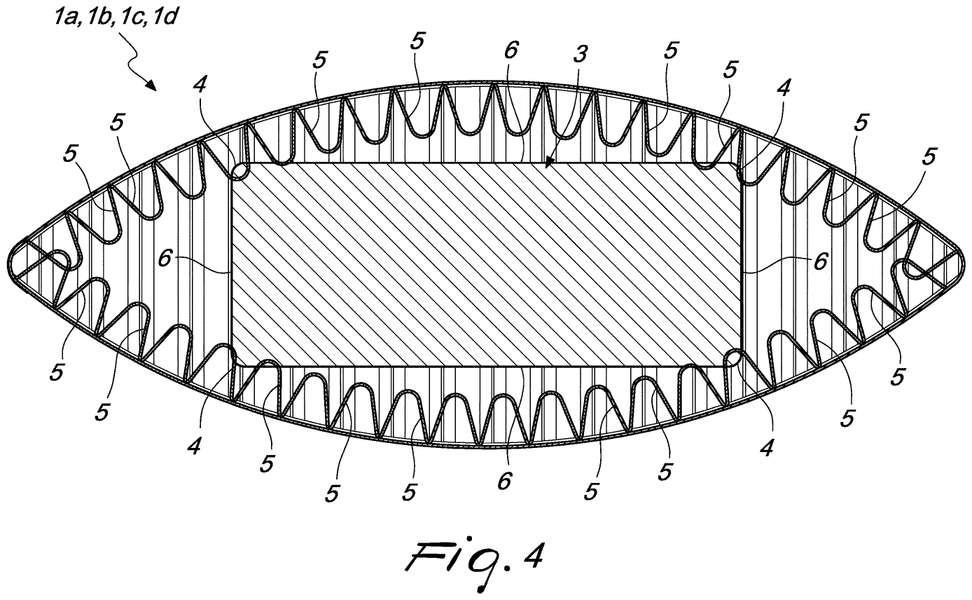

Moreover, with reference to FIG. 2, the two lateral faces 17 of the packaging 1a, 1b, 1c or 1d are concave.

In fact, as a result of the particular shape of the creasing and cutting, the ends, after they have been folded, assume a concave geometry which, although in resting contact with the item to be packaged 3, protects it from any impacts being absorbed by the edges of the enclosure.

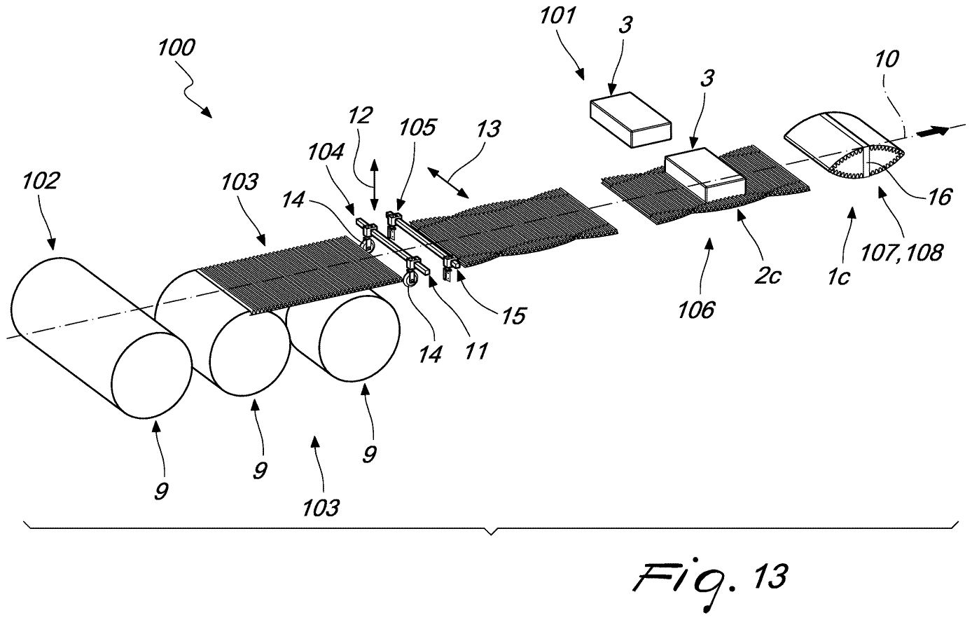

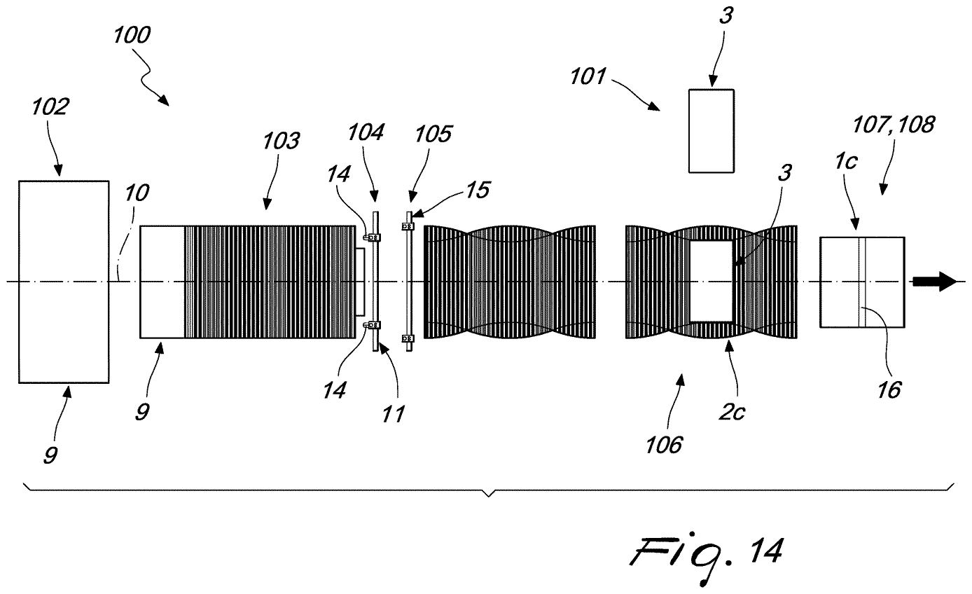

With reference to FIGS. 12 and 13, a packaging production line 1c, generally designated by the reference numeral 100, is shown and comprises:
a loading station 101, in which the dimensions and weight of an item to be packaged 3 are measured by virtue of measurement means, not shown for the sake of simplicity in illustration;
a magazine 102 of rolls 9 of corrugated cardboard of different sizes;
calculation means adapted for the identification of the roll 9 of corrugated cardboard and of the shaped element 2c that are most adapted for the provision of a packaging lc adapted to contain the item to be packaged 3 on the basis of measurements taken in the loading station 101 by the measurement means;
a station for picking up and unrolling 103 the roll 9 along an advancement line 10 from which the shaped element 2c is to be obtained;
a creasing station 104, comprising a creasing device 11 which is movable along a first direction 12 that is perpendicular to the working surface on which the roll 9 is unrolled, so as to allow its approach and spacing with respect to the unrolled roll 9, and along a second direction 13 that is perpendicular to both the first direction 12 and the advancement line 10, so as to crease the unrolled roll 9 along the folding lines 7 calculated by the calculation means by combining the relative motion between the unrolled roll 9 as it advances along the advancement line 10 and the creasing blades 14 of the movable creasing device 11 which can move along the second direction;
a cutting station 105, comprising one or more blades 15 which can move along the first direction 12, in such a manner as to allow them to move toward and away from the unrolled roll 9, and along the second direction 13, so as to cut the unrolled roll 9 to obtain the shaped element 2c calculated by the calculation means by combining the relative motion between the unrolled roll 9 advancing along the advancement line 10 and the blades 15 which can move along the second direction 13;
a positioning station 106, in which the item to be packaged 3 is positioned on the shaped element 2c obtained from the cut and creased roll 9;
a folding station 107, in which the shaped element 2c is closed onto the item to be packaged 3 by wrapping and wedging it at its edges 4 between the corrugations 5 of the corrugated cardboard and with its main faces 6 spaced from the walls of the shaped element 2c so as to allow the elastic deformation of the walls in the direction of the item to be packaged 3 in the event of accidental falls and/or impacts by taking advantage of the elastic properties of corrugated cardboard;
a sealing station 108, in which the shaped element 2c is sealed by means of adhesive tape 16 and labeled.

According to the requirements, the cutting station 105 can be arranged after the creasing station 106, as shown in FIGS. 11 and 12, or can be arranged before the creasing station 105.

Furthermore, the folding station 107 and the sealing station coexist in a single final station.

The method for providing the packaging for transport 1a, 1b, 1c and 1d described above, which can be provided by means of the production line 100 that has just been described, comprises the following steps:
loading an item to be packaged 3, in which the dimensions and weight thereof are detected by virtue of measurement means;
identifying, by virtue of the calculation means, the roll 9 of corrugated cardboard and the shaped element 2a, 2b, 2c, 2d that are most adapted for the provision of a packaging 1a, 1b, 1c or 1d adapted to contain the item to be packaged 3 on the basis of the measurements made by the measurement means;
picking up and unrolling the roll 9 along an advancement line 10 and obtaining the shaped element 2a, 2b, 2c, 2d from the roll;
creasing the unrolled roll 9 along folding lines 7 calculated by the calculation means by combining the relative motion between the unrolled roll 9 that is advancing along the advancement line 10 and the creasing blades 11 of a creasing device 12 which can move transversely with respect to the advancement line 10;
cutting the unrolled roll 9 to obtain the shaped element 2a, 2b, 2c, 2d calculated by the calculation means by combining the relative motion between the unrolled roll 9 that is advancing along the advancement line 10 and blades 15 which can move transversely with respect to the advancement line 10;
positioning the item to be packaged 3 on the shaped element 2a, 2b, 2c, 2d obtained from the cut and creased roll 9;
folding the shaped element 2a, 2b, 2c, 2d over the item to be packaged 3 by wrapping it and wedging it at its edges 4 between the corrugations 5 of the corrugated cardboard and with its main faces 6 spaced from the walls of the shaped element 2a, 2b, 2c, 2d so as to allow the elastic deformation of the walls in the direction of the item to be packaged 3 in the event of accidental falls and/or impacts, taking advantage of the elastic properties of the corrugated cardboard;
sealing the shaped element 2a, 2b, 2c, and 2d by means of adhesive tape 16 and labeling it.

In greater detail, in the calculation step, the design of the shaped elements 2a, 2b, 2c and 2d takes into account the dimensions of the element to be packaged 3, its inherent fragility, the cushioning capabilities of the corrugated cardboard with high thickness, and the necessary distance between the main faces 6 of the element to be packaged 2 with the internal walls of the packaging 1a, 1b, 1c or 1d.

Moreover, in the sealing step, the shaped elements 2a, 2b, 2c and 2d made of corrugated cardboard are spliced to close in a loop, so as to form the packaging 1a, 1b, 1c or 1d before shipment directly in the production line 100 in an automated manner.

It has been found in practice that the packaging, the line and the method, according to the present invention, achieve the intended aim and objects.

In fact, the combination of the use of thick corrugated cardboard and the prism-like shape with a substantially elliptical base allows to obtain a shock-absorbing packaging in which the internal walls are well spaced from the main faces of the element to be packaged.

Moreover, the use of corrugated cardboard allows to have a shock-absorbing support also at the point of contact between the packaging and the edges of the item to be packaged.

In greater detail, the orientation of the ribs of the shock-absorbing corrugated cardboard allows to have a wall that is rigid in one direction, normally termed rib direction, and flexible in the direction of the corrugation, so that the cardboard can be folded.

This characteristic allows the two major surfaces of the package to be curved but at the same time ribbed, allowing elastic bending thereof in one direction and being rigid in the other.

In summary, the advantages of the transport packaging according to the present invention consist in:
having the main faces of the element to be packaged well spaced from the internal walls of the packaging;
being simple to use, preventing assembly errors;
taking advantage of the cushioning capabilities of thick corrugated cardboard at the contact points between the element to be packaged and the packaging;
fall protecting the sides by combining the cushioning capabilities of corrugated cardboard with the calculated elastic deformation of the curved walls of the packaging;
ensuring increased damping in falls on the edges, thanks to the particular pointed shape of the corners;
being easy to manufacture, since it is constituted by a contoured and creased sheet of thick cardboard;
being economical, easy to use and dispose of;
being producible with recycled and recyclable material;
being producible on demand and therefore being integrable into automated packaging systems that sequentially handle products of different sizes, typically in e-commerce packaging.

The packaging, the line and the method thus conceived are susceptible of numerous modifications and variations, all of which are within the scope of the accompanying claims.

Moreover, all the details may be replaced with other technically equivalent elements.

In practice, the materials used, so long as they are compatible with the specific use, as well as the contingent shapes and dimensions, may be any according to the requirements and the state of the art.

1-9. (canceled)

10. A transport packaging having a high shock-absorbing effect, comprising a shaped element made of corrugated cardboard and having, in a flat extension thereof, a shape adapted to be folded back on itself to form a three-dimensional shape; wherein said shaped element has, in said three-dimensional shape, a prism-like geometry with a substantially elliptical base to accommodate an item to be packaged wedged at edges thereof between corrugations of said corrugated cardboard and with main faces thereof spaced from the walls of said shaped element so as to allow an elastic deformation of said walls in a direction of said item to be packaged in case of accidental falls or impacts, taking advantage of elastic properties of said corrugated cardboard.

11. The packaging according to claim 10, wherein folding lines of said shaped element are provided by creasing and are oriented substantially transversely to an orientation of said corrugations of said corrugated cardboard.

12. The packaging according to claim 10, wherein said shaped element comprises at least one closing tab which is configured to be superimposed, in said three-dimensional configuration, on an outer portion of said shaped element in order to seal said shaped element.

13. The packaging according to claim 10, wherein in said three-dimensional shape two lateral faces of said shaped element are concave.

14. A production line for manufacturing a transport packaging according to claim 10, comprising:
a loading station, in which dimensions and weight of an item to be packaged are measured by measurement means;
a magazine of rolls of corrugated cardboard of different sizes;
calculation means adapted for an identification of the roll of corrugated cardboard and of the shaped element that are most adapted for the provision of a packaging adapted to contain said item to be packaged on the basis of measurements taken in said loading station by said measurement means;
a station for picking up and unrolling said roll along an advancement line from which said shaped element is to be obtained;
a creasing station, comprising a creasing device which is movable along a first direction that is perpendicular to a working surface on which said roll is unrolled, so as to allow approach and spacing of said creasing device with respect to said unrolled roll, and along a second direction that is perpendicular to both said first direction and an advancement line, so as to crease said unrolled roll along folding lines calculated by said calculation means by combining a relative motion between said unrolled roll that is advancing along said advancement line and creasing blades of said creasing device which can move along said second direction;
a cutting station, comprising one or more blades which can move along said first direction, in such a manner as to allow said blades to move toward and away from said unrolled roll, and along said second direction, so as to cut said unrolled roll to obtain said shaped element calculated by said calculation means by combining the relative motion between said unrolled roll advancing along said advancement line and said blades which can move along said second direction;
a positioning station, in which said item to be packaged is positioned on said shaped element obtained from said cut and creased roll;
a folding station, in which said shaped element is closed onto said item to be packaged by wrapping and wedging at its edges between the corrugations of said corrugated cardboard and with main faces thereof spaced from the walls of said shaped element so as to allow the elastic deformation of said walls in the direction of said item to be packaged in the event of accidental falls and/or impacts by taking advantage of the elastic properties of said corrugated cardboard; and
a sealing station, in which said shaped element is sealed by means of adhesive tape and labeled.

15. The production line according to claim 14, wherein said cutting station is located after said creasing station.

16. The production line according to claim 14, wherein said cutting station is located ahead of said creasing station.

17. The production line according to claim 14, wherein said folding station and said sealing station coexist in a single final station.

18. A method for providing a transport packaging by means of a production line according to claim 14, comprising the following steps:
loading an item to be packaged and detecting dimensions and weight of said item to be packaged by measurement means;
identifying, by calculation means, a roll of corrugated cardboard and a shaped element that are most adapted for the provision of a packaging adapted to contain said item to be packaged on the basis of the measurements made by said measurement means;
picking up and unrolling said roll along an advancement line and obtaining said shaped element from said roll;
creasing said unrolled roll along folding lines calculated by said calculation means by combining a relative motion between said unrolled roll that is advancing along said advancement line and creasing blades of a creasing device which can move transversely with respect to said advancement line;
cutting said unrolled roll to obtain said shaped element calculated by said calculation means by combining the relative motion between said unrolled roll that is advancing along said advancement line and blades which can move transversely with respect to said advancement line;
positioning said item to be packaged on said shaped element obtained from said cut and creased roll;
folding said shaped element over said item to be packaged by wrapping the item and wedging the item at edges thereof between the corrugations of said corrugated cardboard and with main faces thereof spaced from the walls of said shaped element so as to allow the elastic deformation of said walls in the direction of said item to be packaged in the event of accidental falls and/or impacts, taking advantage of the elastic properties of said corrugated cardboard; and
sealing said shaped element by means of adhesive tape and labeling said shaped element.
